(19) United States
(12) Patent Application Publication
(10) Pub. No.: US 2002/0157707 A1
(43) Pub. Date: Oct. 31, 2002

(54) Pressure cutoff valve

(76) Inventor: Ronald Spencer Sampson, Sydney (AU)

Correspondence Address: Jacobson & Johnson, Suite 285, One West Water St., St. Paul, MN, 55106-2033, US

(21) Appl. No.: 09/818,364

(22) Filed: Mar. 27, 2001

(30) Foreign Application Priority Data
Oct. 28, 1998 (AU) PP6767

(51) Int. Cl. F16K 37/00

(52) U.S. Cl. 137/224; 137/227

(57) ABSTRACT

There is a valve assembly for controlling the admission of a fluid such as air into a vehicle tyre or other pressure vessel. The assembly includes a housing (1) with a valve assembly (10) movable therein by a predetermined pressure in said vessel against a spring 5A. The valve member (10) is movable from a first position at which ports (14) of an inlet passage (13) in the housing (1) are open to fluid flow into the vessel to a second position at which the ports (14) are closed by the valve member (10). In use of the valve assembly when the valve member (10) is biased to the first position by the spring 5A the fluid can flow into the vessel until pressure therein reaches the predetermined pressure and the valve member (10) is moved to the second position to terminate flow into the vessel. The valve assembly also includes a low pressure indicating means comprising a transparent cap 3A with an opaque band (23) and a collar (8) movable with the valve member (10).

### FIELD OF THE INVENTION

This invention relates to valves. More particularly although not exclusively it discloses an improved valve for vehicle tyres.

### BACKGROUND OF THE INVENTION

Virtually all vehicle and tyre manufacturers publish recommended air pressures for various loads and types of driving. Maintaining such tyre pressures is of considerable importance. Low pressure causes excessive heat build-up due to flexing of the tyre side walls and can lead to premature failure. Excessively high pressure on the other hand reduces tyre grip on the road especially in the wet. It can also lead to excessive wear or “scuffing” at the centre of the tread which shortens tyre life. While most people appreciate the need to maintain recommended pressure they often forget to regularly check their tyres. Also the air gauges at most service stations are often inaccurate and/or difficult to read. The dual calibrations in psi and kpa on most pressure gauges can also lead to confusion.

### SUMMARY OF THE INVENTION

It is therefore an object of this invention to ameliorate the aforementioned disadvantages and accordingly a valve assembly is disclosed for controlling admission of a fluid such as air into a vehicle tyre or other pressure vessel, said assembly including a housing with a valve member movable by a predetermined pressure in said vessel against a spring bias from a first position at which one or more ports of an inlet passage in said housing are open to fluid flow into said vessel to a second position at which said ports are closed by said valve member whereby in use of said valve assembly when said valve member is biased to said first position said fluid can flow into the vessel until pressure therein reaches said predetermined fluid pressure and the valve member is moved to said second position to terminate flow into said vessel.

Preferably the valve assembly includes a visual and/or audio indicating means which alerts a user when the pressure falls below said predetermined pressure.

It is further preferred that said valve assembly include a Schrader type valve upstream of said valve member to prevent fluid discharge when the pressure falls below said predetermined pressure whereby said ports are open.

### BRIEF DESCRIPTION OF THE DRAWINGS

One currently preferred embodiment of this invention will now be described with reference to the attached drawings in which:

FIG. 1 is a elevation view of an air valve assembly according to this concept which may be used on a pneumatic vehicle tyre.

FIG. 2 is a cross-sectional view along the lines A-A of FIG. 1 with the valve member in the open position, and

FIG. 3 is a cross-sectional view similar to FIG. 2 but with the valve member in the closed position.

### DETAILED DESCRIPTION OF THE PREFERRED EMBODIMENT

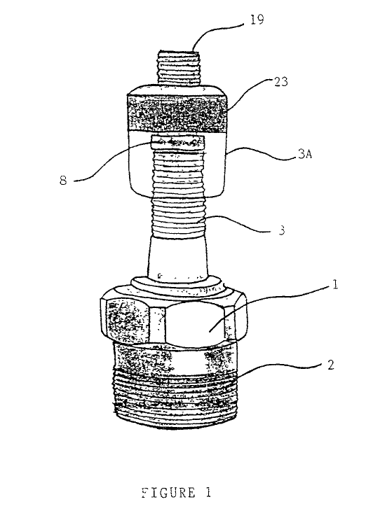

Referring first to FIG. 1 the valve assembly may comprise a housing with an hexagonal shaped lower portion 1 and threaded shank 2 for turning into a tyre rim or other fitting of a pressure vessel. An upper stem portion 3 of the housing is also threaded to mate with a transparent indicator cap 3A the purpose of which will be described later.

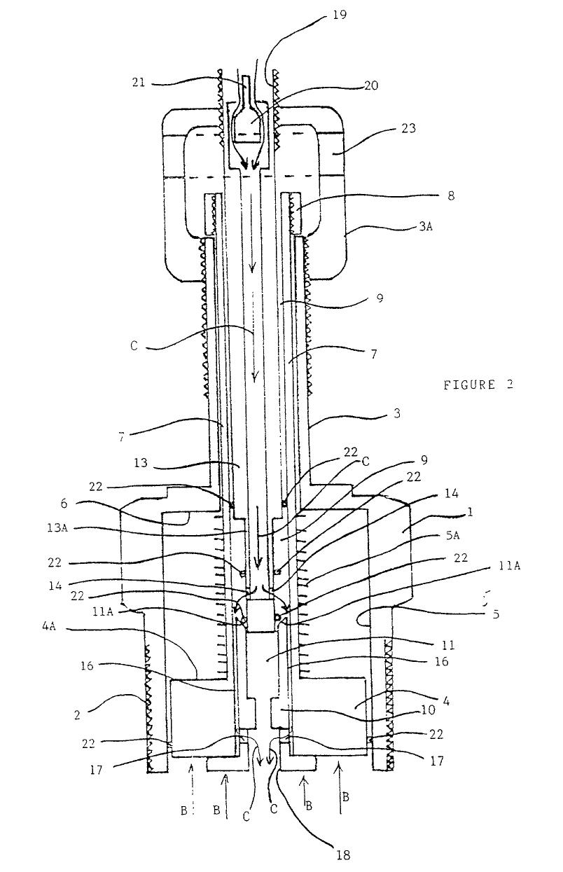

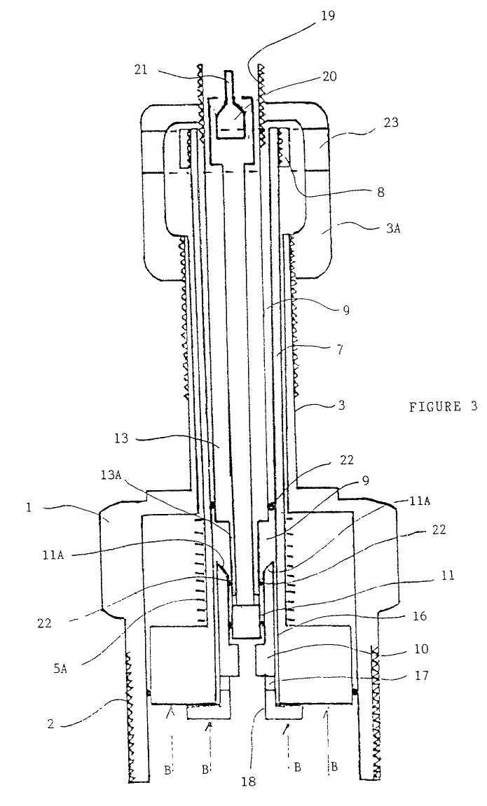

As best shown by the cross-sections of FIGS. 2 and 3 a pressure sensitive member is mounted within the housing which controls the cutoff action of the device. With this particular embodiment it comprises a piston 4 which is slidable within a cylindrical open ended lower portion 5 of the housing. The piston 4 is biased down to the open position shown in FIG. 2 by a spring 5A acting between an upper face 4A of this piston and an inside shoulder 6 of the housing. The piston member also includes a pipe 7 which extends up through the stem 3 of the housing and terminates at a threaded end fitted with a collar 8. In FIG. 2 this collar abuts the top of the housing stem and holds the piston 4 in the position shown against the downward force of the spring 5A. There is a longitudinal bore 9 which extends continuously through the piston and pipe. Push fitted into the bottom of this longitudinal bore is a cutoff valve 10 with a cavity 11 and inwardly tapering edge 11A. Located inside the pipe is a fluid conduit 13. The position of this fluid conduit 13 within the housing stem 3 is maintained by the cap 3A which threads over both components. By changing the position of the threaded cap 3A on the stem 3 the location of the conduit 13 within the pipe 7 is adjusted and thus the cutoff pressure may be set by the user. The lower end 13A of the conduit is sized to slidably fit into the cavity 11 in the valve member. There are also ports 14 adjacent the bottom (outlet end) 13A of this conduit, channels 16 down the side of the valve member which lead to apertures 17 into the central part of the valve member and an outlet 18 to the pressure vessel. The upper (inlet end) 19 of the conduit is fitted with a Schrader type valve 20 or the like which allows fluid under pressure into the fitting but blocks return flow unless a spring loaded pin 21 is manually depressed.

In order to obtain an effective fluid seal in the valve assembly a series of O rings 22 or other suitable sealing members are seated between the various moving parts as shown.

In operation, the valve assembly when fitted say a vehicle tyre (not shown), would operate between the two configurations shown in FIGS. 2 and 3. When the tyre contains less than a predetermined air pressure of say 250 kpa the force exerted on the bottom of the piston 4 (arrows B) would be insufficient to overcome the bias of the spring 5A. Therefore the valve assembly would adopt the configuration shown in FIG. 2 with the ports 14 open and flow out through the device blocked only by the Schrader valve 20 at the inlet. However, high pressure air applied to the inlet through a suitable fitting would open the Schrader valve and pass through the valve assembly along the route shown by arrows C. In this configuration the collar 8 (as also shown in FIG. 1) is clearly visible through the transparent cap 3A as it sits below the opaque band 23. Although not shown in the drawings this collar 8 is preferably of some conspicuous colour such as red so that it is clearly noticeable when in this position. As the pressure within the tyre increases to about 250 kpa the force on the bottom of the piston 4 increases accordingly until it is sufficient to overcome the spring bias and push the piston 4 and valve member 10 upward to the configuration shown in FIG. 3. Here the valve cavity 11 has moved upward to close off the ports 14 at the outlet end of the fluid conduit 13. The inward flow of air into the tyre through the valve assembly is thus terminated. It will be noted from FIG. 3 that the collar 8 has also moved upward with the piston and valve so that it is now hidden from view behind the opaque band 23. An audio device may also be activated at this point to alert the user that the cutoff pressure has been reached.

In use of the device on say an automobile tyre the user would be quickly alerted to low pressure by the appearance of the coloured collar 8 within the transparent cap. To inflate the tyre a conventional air hose and nozzle is used as installed at petrol stations. However, the accuracy of the station pressure guage is not important as once the predetermined pressure of say 250 kpa is reached the valve would automatically move to the configuration of FIG. 3 and cutoff any further air flow into the tyre as described above. The coloured collar 8 would also disappear from view until the tyre pressure again drops below the recommended value.

Although not shown in the drawings it is envisaged that a one way valve may also be fitted to the outlet end 13A of the flow conduit. This would be linked mechanically to the Schrader valve so that air could be discharged from the tyre at any time by manual depression of the pin 21.

If is further envisaged that in conjunction with or as an alternative to the collar 8 an audio alarm may be incorporated into the valve assembly to additionally alert the user to low pressure.

In order to fit the valve to a tubeless tire rim it would preferably be encased in rubber.

It will thus be appreciated that this invention at least in the form of the embodiment disclosed provides a novel and improved valve for vehicle tyres or other pressure vessels. Clearly however a wide variety of modifications may be made which would be apparent to a person skilled in the art. For example the shape and configuration of valve housing as well as the components therein and the predetermined cutoff pressure may all be changed according to application or design preference. Also, although the valve has been described with reference to use on pneumatic vehicle tyres the device may within the scope of this invention be adapted for use with any type of gas or liquid pressure vessel.

For the purposes of this specification expressions such as “lower”, “upper”, “down”, “top”, “downward”, “bottom” and “upward” etc. refer to the valve assembly in one possible position of use as illustrated and are not to be read as necessarily limiting.

The claims defining the invention are as follows:

1. A valve assembly for controlling the admission of a fluid such as air into a vehicle tyre or other pressure vessel, said assembly including a housing with a valve member therein movable by a predetermined pressure in said vessel against a bias from a first position at which one or more ports of an inlet passage in said housing are open to fluid flow into said vessel to a second position at which said ports are closed by said valve member whereby in use of said valve assembly when said valve member is biased to said first position said fluid can flow into the vessel until pressure therein reaches said predetermined pressure and the valve member is moved to said second position to terminate flow into said vessel.

2. The valve assembly as claimed in claim 1 wherein a second valve member is disposed in the inlet passage upstream of said one or more ports to prevent discharge out through said inlet passage when the pressure falls below said predetermined pressure and said ports are open.

3. The valve assembly as claimed in claim 2 wherein said valve assembly includes an indicating means to alert a user when the pressure in said vessel falls below said predetermined pressure.

4. The valve assembly as claimed in claim 3 wherein said indicating means includes a coloured collar within a transparent cap fitted to a stem of said housing.

5. The valve assembly as claimed in claim 4 wherein said bias is a spring bias.

6. The valve assembly as claimed in claim 5 wherein said valve member is formed with a cavity which is slidable over a portion of said inlet passage to close said ports.

7. The valve assembly as claimed in claim 6 wherein said valve assembly is fitted to a piston which is slidable within an internal cylindrical portion of said housing, said piston being biased to place said valve member in said first position by a spring acting between an inner end of said piston and an inside shoulder of the housing, an opposite face of said piston being exposed to the fluid pressure in said vessel.

8. The valve assembly as claimed in claim 1 wherein said piston includes a pipe which extends through the stem of said housing to mount said collar.

9. The valve assembly as claimed in claim 8 wherein at said first position of said valve member said collar is visible within said cap and at said second position of said valve member the collar is concealed behind an opaque band around said cap.

10. A vehicle tyre or other pressure vessel when fitted with a valve assembly as claimed in claim 1.
